(19) United States
(12) Patent Application Publication
(10) Pub. No.: US 2020/0061630 A1
(43) Pub. Date: Feb. 27, 2020

(54) PRELOAD TYPE GRANULATOR

(71) Applicant: SINO-ALLOY MACHINERY INC., Kuan-Yin estate (TW)

(72) Inventor: Mei-Chuan CHEN, Kuan-Yin estate (TW)

(21) Appl. No.: 16/112,738

(22) Filed: Aug. 26, 2018

(51) Int. Cl. B02C 18/24; B02C 25/00; B29B 9/02

(52) U.S. Cl. CPC B02C 18/24; B02C 2018/164; B29B 9/02; B02C 25/00

(57) ABSTRACT

A preload type granulator includes a drive unit, a transmission unit including a transmission sleeve rotatable by the drive unit and having oblong slots cut through the peripheral wall thereof, two elastic modules with different spring coefficients connected in series and axially mounted in the transmission sleeve, and a cutting unit including a connecting shaft abutted with a bottom side thereof against the elastic modules and fastened to the transmission sleeve by screw bolts that are respectively inserted through the oblong slots and threaded into the connecting shaft, a cutter holder mounted on the connecting shaft and a plurality of cutting tools mounted on cutter holder. Thus, the series of elastic modules generates a constant spring pressure to adjust the pressure between the cutting tools and the die face, controlling the friction between the cutting tools and the die face.

### BACKGROUND OF THE INVENTION

### 1. Field of the Invention

The present invention relates to granulator technology and more particularly to a preload type granulator for cutting plastic into granules, which a cutting unit, a drive unit, and a transmission unit coupled between the cutting unit and the drive unit and provided with a series of two sets of springs with different elastic coefficients that generates a constant spring pressure to adjust the pressure between the cutting unit and the die surface, controlling the friction between the cutting unit and the die surface and improving the service life of the cutting tools.

### 2. Description of the Related Art

Most granulators are used to make plastic granules. These granulators commonly use a motor to rotate cutting tools, and the cutting tools are pressed against the die face. When the material is extruded by the die face, the cutting tools cut the material into granules.

In order to slow the wear rate of the cutting tools and the die face, a sliding device is provided between the cutting tools and the drove unit to control the position of the cutting tools so that the relative position between the cutting tools and the die face can be controlled. However, the movement of the sliding device is controlled by an electronic instrument, which is relatively large in volume, requires a large installation space, and has a high installation cost.

### SUMMARY OF THE INVENTION

The present invention has been accomplished under the circumstances in view. It is therefore the main object of the present invention to provide a preload type granulator, which uses a pure mechanical structure to control the pressure between the die face and the cutting unit, thereby controlling the friction between the cutting unit and the die face.

To achieve this and other objects of the present invention, a preload type granulator comprises a drive unit, a transmission unit and a cutting unit. The drive unit comprises a motor and a motor shaft rotatable by the motor. The transmission unit comprises a transmission sleeve and two elastic modules with different spring coefficients. The transmission sleeve is mounted on the motor shaft. The transmission sleeve comprises an axially disposed mounting portion and a plurality of oblong slots cut through the peripheral wall thereof. The two elastic modules are connected in series and mounted in the mounting portion. The cutting unit comprises a cutter holder, a connecting shaft and a plurality of cutting tools. The cutting tools are mounted on the cutter holder. The cutter holder is mounted with the center thereof onto the connecting shaft. The connecting shaft is fastened to the transmission sleeve by screw bolts that are respectively inserted through the oblong slots and threaded into the connecting shaft. The connecting shaft is abutted with a bottom side thereof against the elastic modules so that the preload stroke of the cutting unit is adjustable by means of the two elastic modules.

Thus, the elastic coefficient of the two elastic modules is used to adjust the pressure and distance between the cutting unit and the die face, and the relative positioning between the screw bolts and the oblong slots is used to adjust the displacement stroke of the cutting unit. Thus, the cutting unit can produce different constant pressure on the die face according to different granulation requirements for different materials.

When the preload type granulator is used to cut plastic into granules, the die face is moved toward the cutting unit, When the cutting tools of the cutting unit touch the die face, the cutting tools are displaced toward the preload stroke. Thus, the elastic coefficient of the elastic modules adjusts the relative distance between the cutting tools and the die face, thereby controlling the friction between the cutting tools and the die face. This improves the life of the cutting tools, controls the loss of the die face, and reduces the contamination of the metal material. Since the two elastic modules mechanically controls the distance between the cutting unit and the die face, no mechanical operations are required.

### BRIEF DESCRIPTION OF THE DRAWINGS

FIG. 1 is an oblique top elevational view of a preload type granulator in accordance with the present invention.

FIG. 2 is a schematic applied view of the preload type granulator in accordance with the present invention

FIG. 3 is a longitudinal sectional view of the preload type granulator in accordance with the present invention.

FIG. 4 is an enlarged view of a part of the present invention, illustrating the configuration of the transmission unit.

### DETAILED DESCRIPTION OF THE PREFERRED EMBODIMENT

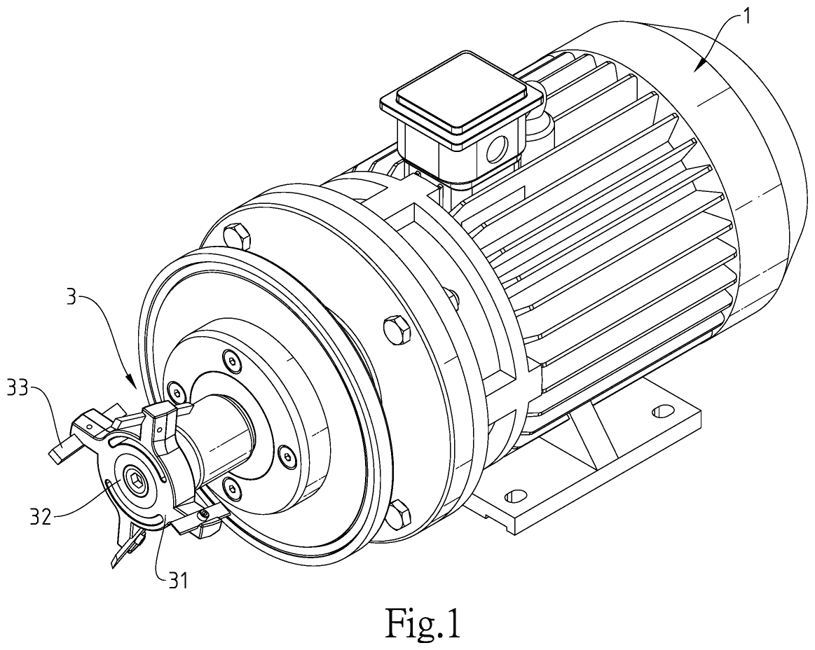

Referring to FIGS. 1-4, a preload type granulator in accordance with the present invention is shown. The preload type granulator comprises a drive unit (1), a transmission unit (2) and a cutting unit (3).

The drive unit (1) comprises a motor (11), and a motor shaft (12) driven to rotate by the motor (11). The motor shaft (12) comprises a locating groove (13), and a drive key (14) that sits partly into the locating groove (13) and partly into the transmission unit (2) so that the drive unit (1) can drive the transmission unit (2).

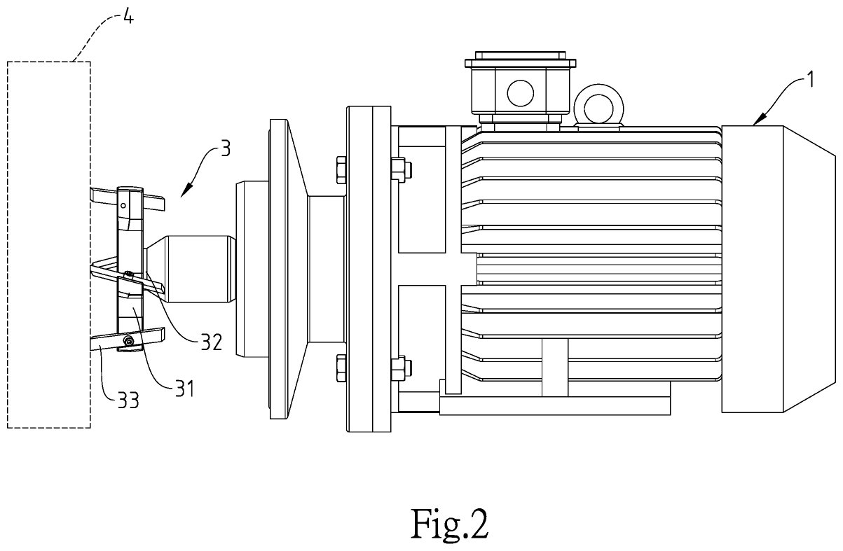

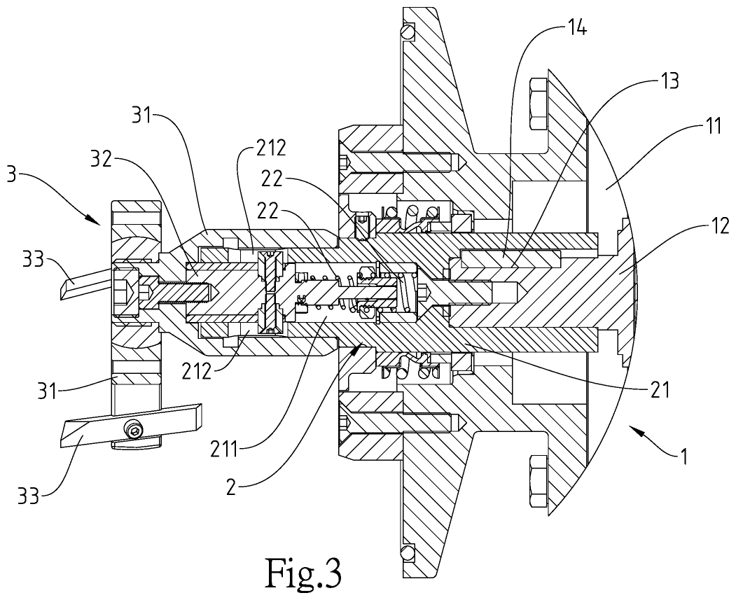

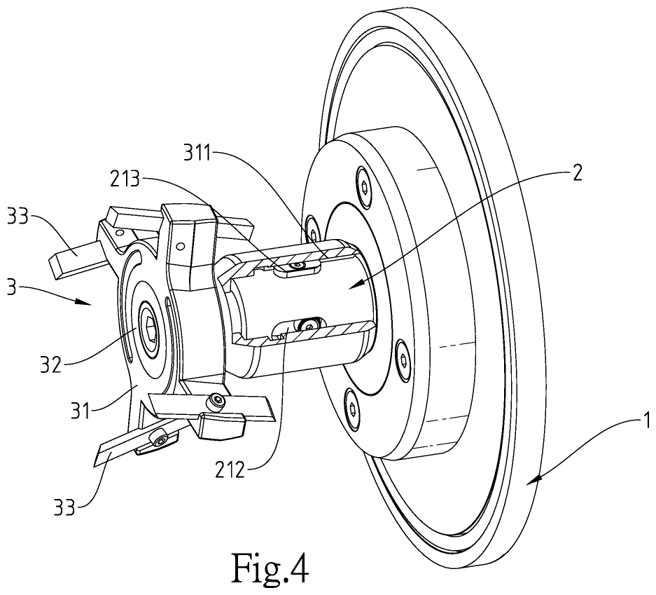

The transmission unit (2) comprises a transmission sleeve (21) and two sets of elastic modules (22) with different spring coefficients. The transmission sleeve (21) is mounted on the motor shaft (12). More specifically, as illustrated in FIG. 3, the transmission sleeve (21) is axially coupled to the motor shaft (12) by a coupling bolt and provided with a mounting portion (211) along the axial direction thereof. The two elastic modules (22) are connected in series and then mounted in the mounting portion (211). As illustrated in FIG. 3, the elastic modules (22) are different diameter springs connected in series. Further, the transmission sleeve (21) has a plurality of oblong slots (212) cut through the peripheral wall thereof. As illustrated in FIGS. 2 and 4, the oblong slots (212) are arranged on opposing top and bottom sides of the transmission sleeve (21) (the left and right sides in FIG. 4). Further, in order to prevent yaw during rotation, the surface of the transmission sleeve (21) is further provided with a plurality of transmission keys (213) for driving the cutting unit (3) to rotate synchronously.

The cutting unit (3) comprises a cutter holder (31), a connecting shaft (32) and a plurality of cutting tools (33). These cutting tools (33) are mounted in the cutter holder (31). The connecting shaft (32) is mounted in the center of the cutter holder (31). Screw bolts (not shown) are respectively inserted through the oblong slots (212) and threaded into the connecting shaft (32) to fasten the connecting shaft (32) to the transmission sleeve (21). Further, the connecting shaft (32) is abutted with the bottom side (rear end) thereof against the elastic modules (22). Thus, the preload stroke of the cutting unit (3) can be adjusted by the two elastic modules (22). Further, the cutter holder (31) has a plurality of transmission key grooves (311) located on an inside wall thereof corresponding to the transmission keys (213). After the cutter holder (31) is coupled to the transmission sleeve (21), the cutter holder (31) can be driven by the transmission sleeve (21) to rotate the cutting tools (33).

Referring to FIGS. 1-4 again, the manner of use of the present invention and the advantages the present invention can achieve are as follows:

1. The operator selects the corresponding elastic modules (22) according to the material characteristics of the die face (4), such as springs with different wire diameters, springs with different diameters, springs of different materials and different lengths, and then connects the two elastic modules (22) in series and mounts the series of elastic modules (22) in the mounting portion (211) of the transmission sleeve (21), and then mounts the connecting shaft (32) axially in the transmission sleeve (21), and then mounts respective screw bolts through the oblong slots (212) to adjust the preload stroke of the connecting shaft (32), and then mounts the cutting tools (33) in the cutter holder (31) and mounts the cutter holder (31) and the connecting shaft (32) together.

2. When the preload type granulator is used to cut plastic into granules, move the die face (4) toward the cutting unit (3), When the cutting tools (33) of the cutting unit (3) touch the die face (4), the cutting tools (33) are displaced toward the preload stroke. The elastic coefficient of the elastic modules (22) adjusts the relative distance between the cutting tools (33) and the die face (4), thereby controlling the friction between the cutting tools (33) and the die face (4) (that is, cutting with the smallest contact surface). This improves the life of the cutting tools (33), controls the loss of the die face (4), and reduces the contamination of the metal material. Since the two elastic modules (22) mechanically controls the distance between the cutting unit (3) and the die face (4), no mechanical operations are required.

What the invention claimed is:

1. A preload type granulator, comprising:
a drive unit comprising a motor and a motor shaft rotatable by said motor;
a transmission unit comprising a transmission sleeve and two elastic modules with different spring coefficients, said transmission sleeve being mounted on said motor shaft, said transmission sleeve comprising an axially disposed mounting portion and a plurality of oblong slots cut through the peripheral wall thereof, said two elastic modules being connected in series and mounted in said mounting portion; and
a cutting unit comprising a cutter holder, a connecting shaft and a plurality of cutting tools, said cutting tools being mounted on said cutter holder, said cutter holder being mounted with the center thereof onto said connecting shaft, said connecting shaft being fastened to said transmission sleeve by screw bolts that are respectively inserted through said oblong slots and threaded into said connecting shaft, said connecting shaft being abutted with a bottom side thereof against said elastic modules so that the preload stroke of said cutting unit is adjustable by means of said two elastic modules.

2. The preload type granulator as claimed in claim 1, wherein said motor shaft further comprises a locating groove, and a drive key that sits partly into said locating groove and partly into said transmission unit for enabling said drive unit to drive said transmission unit to rotate.

3. The preload type granulator as claimed in claim 1, wherein said transmission sleeve comprises a plurality of transmission keys for driving said cutting unit to rotate synchronously; said cutter holder comprises a plurality of transmission key grooves located on an inside wall thereof and respectively coupled to said transmission keys for enabling said cutter holder to be rotated by said transmission sleeve.
